(19) United States
(12) Patent Application Publication
(10) Pub. No.: US 2024/0133635 A1
(43) Pub. Date: Apr. 25, 2024

(54) PLATE-TYPE HEAT EXCHANGER AND METHOD FOR FABRICATING THE SAME

(71) Applicant: SHINHAN APEX CORPORATION, Incheon (KR)

(72) Inventor: Mun-Jae CHO, Seoul (KR)

(21) Appl. No.: 18/381,780

(22) Filed: Oct. 18, 2023

(30) Foreign Application Priority Data
Oct. 19, 2022 (KR) 10-2022-0135459
Aug. 22, 2023 (KR) 10-2023-0110351

(51) Int. Cl. F28D 9/00; B21D 53/04

(52) U.S. Cl. CPC F28D 9/0062; B21D 53/04

(57) ABSTRACT

A plate type heat exchanger wherein the heat transfer assembly includes a plurality of heat transfer shells stacked in multiple layers.

### CROSS-REFERENCE TO RELATED APPLICATIONS

This application claims the benefit and priority of Korean Patent No. 10-2022-0135459 filed Oct. 20, 2022 and Korean Patent No. 10-2023-0110351 filed Aug. 23, 2023. The entire disclosures of each of the above applications are incorporated herein by reference.

### TECHNICAL FIELD

The present invention relates to a plate-type heat exchanger and a method of manufacturing the same, and more specifically to a plate-type heat exchanger in which the number of flange portions that are formed to be bent and in contact with each other at the edge of a heat conduction plate is reduced to increase the heat transfer area per unit area of the heat conduction plate in contact with the high-temperature exhaust gas; and the resistance generated when the area where the heat conduction plates are welded to each other comes into contact with the high-temperature exhaust gas flowing inward can be reduced, and a method of manufacturing the same.

### BACKGROUND ART

In general, a heat exchanger is a fluid-to-fluid type heat recovery device that recovers heat contained in exhaust gas discharged to the outside from industrial facilities and air-conditioning facilities and supplies it to production facilities or indoors.

This heat exchanger is classified into a plate-type heat exchanger, a heat pipe-type heat exchanger, and a disk-type heat exchanger, etc., depending on the type of a heat exchange module, which is a core part provided therein.

The plate-type heat exchanger allows heat transfer (heat exchange) between a high-temperature gas, such as waste heat, and a low-temperature gas, such as gas in the atmosphere, without physical contact with each other.

In such a plate-type heat exchanger, a plurality of plate-shaped heat transfer plates are arranged to be parallel to each other and overlap at predetermined intervals; a space between the respective heat transfer plates becomes a flow path through which fluid flows in one direction; and high-temperature gas and low-temperature gas are supplied alternately to each flow path for each heat transfer plate, allowing heat exchange (heat transfer) to occur through each heat transfer plate, thereby recovering heat.

### DISCLOSURE

### Technical Problem

An object of the present invention is to provide a plate-type heat exchanger in which the number of flange portions that are formed to be bent and in contact with each other at the edge of a heat conduction plate is reduced to increase the heat transfer area per unit area of the heat conduction plate in contact with exhaust gas; and the thermal resistance generated when the area where the heat conduction plates are welded to each other comes into contact with the high-temperature exhaust gas flowing inward can be reduced, and a method of manufacturing the same.

The technical objects to be achieved in the present invention are not limited to the technical object mentioned above, and other technical objects not mentioned will be clearly understood by those skilled in the art from the following description.

### Technical Solution

According to one aspect of the present invention, provided is a plate-type heat exchanger including a heat transfer assembly, wherein the heat transfer assembly includes a plurality of heat transfer shells stacked in multiple layers, wherein each of the heat transfer shells include a pair of heat conduction plates; wherein each of the heat conduction plates has a pair of flange portions bent at both side edges, and a first heat transfer portion and a second heat transfer portion facing each other at a certain distance by a bending portion bent and formed in the middle of the length; wherein the heat transfer shell includes a first passage, through which a first fluid passes, formed by welding the end of the first heat transfer portion of one of the pair of heat conduction plates and the end of the second heat transfer portion of the other heat conduction plate in contact with each other and by welding the end of the second heat transfer portion of the one heat conduction plate and the end of the first heat transfer portion of the other heat conduction plate in contact with each other; wherein the plurality of heat transfer shells are stacked in multiple layers by welding both side flange portions of the heat conduction plate provided in the heat transfer shell and both side flange portions of the other heat conduction plate provided in the other heat transfer shell, whereby a second passage through which a second fluid passes is formed between the adjacent heat transfer shells to intersect the first passage; and wherein heat exchange occurs between the first fluid passing through the first passage and the second fluid passing through the second passage without physical contact.

Here, the bending portion may include a first bending portion having an arc-shaped cross-section, which connects the first heat transfer portion and the second heat transfer portion to each other, and a second bending portion having a plate shape, which connects the flange portions formed at both side edges of the first heat transfer portion and the other flange portions formed at both side edge of the second heat transfer portion.

The heat transfer shell may include a pair of heat conduction plates in which the heat transfer areas of the first heat transfer portion and the second heat transfer portion are different from each other; and a plurality of spacing bars that maintain a constant gap formed between the first and second heat transfer portions having different heat transfer areas and facing each other.

The plurality of spacing bars may include a first spacing bar in which one side thereof is welded and connected to a joint area where the respective ends of the first and second heat transfer portions having different heat transfer areas are welded and connected in contact with each other, and the other side is welded and connected to a heat transfer portion corresponding to the joint portion; and a second spacing bar in which both sides thereof are welded and connected in contact with the heat transfer portions facing each other.

In addition, the heat transfer shell may include a pair of heat conduction plates in which the heat transfer areas of the first heat transfer portion and the second heat transfer portion are the same; and a plurality of spacing bars that maintain a constant gap formed between the first and second heat transfer portions having the same heat transfer areas and facing each other.

The plurality of spacing bars may include a first spacing bar in which both sides thereof are welded and connected to both sides of the joint area where the respective ends of the first and second heat transfer portions having the same heat transfer area are welded and connected in contact with each other; and a second spacing bar in which both sides thereof are welded and connected in contact with the first and second heat transfer portions facing each other.

The heat exchanger may include a plurality of vertical frames located at each corner of the heat transfer assembly, an upper frame fixed to each upper end of the plurality of vertical frames so that its lower surface is in contact with the uppermost heat transfer shell among the plurality of stacked heat transfer shells, a lower frame fixed to each lower end of the plurality of vertical frames so that its upper surface is in contact with the lowest heat transfer shell among the plurality of stacked heat transfer shells, and a plurality of stopper bars that are fixed to one side of each of the plurality of vertical frames corresponding to the flange portion of the heat conduction plate to come into contact with the end of the flange portion.

The heat exchanger may include at least one sealing material which is interposed between each other side of the plurality of vertical frames corresponding to the second bending portion formed at both ends of the bending portion, and the second bending portion formed in a flat plate shape.

According to another aspect of the present invention, provided is a method for manufacturing a plate-type heat exchanger, the method including the steps of: providing a square plate-shaped plate; preparing a heat conduction plate by first bending flange portions at both side edges of the plate and secondarily bending a bending portion connecting a first heat transfer portion and a second heat transfer portion so that they face each other and are parallel at a certain distance; forming a heat transfer shell having a first passage, through which a first fluid passes, by welding and connecting an end of the first heat transfer portion of the heat conduction plate and an end of the second heat transfer portion of another heat conduction plate in contact with each other, and by welding and connecting an end of the second heat transfer portion of the heat conduction plate and an end of the first heat transfer portion of the other heat conduction plate in contact with each other; and forming a heat transfer assembly having a second passage, through which a second fluid passes, by stacking a plurality of heat transfer shells in multiple layers so that both side flange portions of the heat conduction plate provided in the heat transfer shell and both side flange portions of another heat conduction plate provided in another heat transfer shell are in contact with each other, whereby the second passage is formed between the adjacent heat transfer shells to intersect the first passage; wherein heat exchange occurs between the first fluid passing through the first passage and the second fluid passing through the second passage without physical contact.

In the step of preparing the heat conduction plate, a mold is used, wherein the mold includes a lower mold body including a first lower mold and a pair of second lower molds each having a bottom surface respectively disposed at both sides of the first lower mold, and an upper mold body including a first upper mold and a pair of second upper molds respectively disposed at both sides of the first upper mold; when the upper mold body is lowered directly downward by an actuator to pressurize the plate and then return upward in a state where the plate having the flange portions formed at both side edges by first bending is placed on the first and second lower molds of the lower mold body, the first and second lower molds of the lower mold body can be joined to the first and second upper molds of the upper mold body with the plate between them and secondarily bend the plate to form the bending portion.

The first lower mold may include a first concave portion with a bottom surface recessed downward, the second lower mold may include a second concave portion with a flat bottom surface; and the first upper mold may include a first convex portion whose lower end corresponding to the first concave portion protrudes convexly downward, and the second upper mold may include a second convex portion whose lower end corresponding to the second concave portion protrudes flatly.

In this case, a first bending portion having an arc-shaped cross-section may be bent and formed by the first concave portion and the first convex portion, while a second bending portion having a plate shape may be bent and formed by the second concave portion and the second convex portion, thereby bending and forming the bending portion in which the second bending portion is continuously formed at both sides of the first bending portion.

In the step of forming the heat transfer shell, the heat transfer shell may include a pair of heat conduction plates in which the heat transfer area of the first heat transfer portion is different from that of the second heat transfer portion, one side of a first spacing bar may be welded and connected to a joint area where the respective ends of the first and second heat transfer portions having different heat transfer areas are welded and connected in contact with each other; the other side of the first spacing bar may be welded and connected to a relatively wide heat transfer portion; and both sides of a second spacing bar may be welded and connected in contact with the heat transfer portions facing each other.

In the step of forming the heat transfer shell, the heat transfer shell may include a pair of heat conduction plates in which the heat transfer area of the first heat transfer portion is the same as that of the second heat transfer portion, both sides of a first spacing bar may be welded and connected to both side joint areas where the respective ends of the first and second heat transfer portions having the same heat transfer areas are welded and connected in contact with each other; and both sides of a second spacing bar may be welded and connected in contact with the heat transfer portions facing each other.

### Advantageous Effects

According to the plate-type heat exchanger of the present invention having the above configuration, the processing cost of the heat conduction plate can be reduced by reducing the number of flange portions that bent and formed at the edge of the heat conduction plate.

In addition, the heat transfer area per unit area of the heat conduction plate in contact with a high-temperature exhaust gas can be increased; and the thermal resistance generated when the area where the heat conduction plates are welded and connected to each other comes into contact with a high-temperature exhaust gas flowing inward can be reduced, thereby increasing the heat exchange efficiency of the plate-type heat exchanger and extending the service life thereof.

It should be understood that the effects of the present invention are not limited to the above effects, and include all effects that can be inferred from the configuration of the invention described in the detailed description or claims of the present invention.

### DESCRIPTION OF DRAWINGS

FIG. 1 is a perspective view showing a heat conduction plate of a plate-type heat exchanger according to an embodiment of the present invention, in which a flange portion is formed to be bent.

FIG. 2 is a perspective view showing a heat conduction plate of a plate-type heat exchanger according to an embodiment of the present invention, in which a bending portion is formed to be bent.

FIG. 3 is a perspective view showing a heat conduction plate of a plate-type heat exchanger according to an embodiment of the present invention, which is provided with a spacer bar.

FIG. 4 is a perspective view showing a heat transfer shell formed by welding the heat conduction plates of a plate-type heat exchanger according to an embodiment of the present invention.

FIG. 5a is a cross-sectional view taken along line 4a-4a in FIG. 4.

FIG. 5b is a cross-sectional view taken along line 4b-4b in FIG. 4.

FIG. 6 is a perspective view showing another heat transfer shell formed in a plate-type heat exchanger according to an embodiment of the present invention.

FIG. 7 is a perspective view showing a heat transfer assembly of a plate-type heat exchanger according to an embodiment of the present invention.

FIG. 8 is a perspective view showing a plate-type heat exchanger according to an embodiment of the present invention.

FIG. 9 is a plan view showing a plate-type heat exchanger according to an embodiment of the present invention.

FIG. 10a is a process diagram showing a process of bending and forming a heat conduction plate in a plate-type heat exchanger according to an embodiment of the present invention.

FIG. 10b is a process diagram showing a process of bending and forming a heat conduction plate in a plate-type heat exchanger according to an embodiment of the present invention.

FIG. 10c is a process diagram showing a process of bending and forming a heat conduction plate in a plate-type heat exchanger according to an embodiment of the present invention.

FIG. 10d is a process diagram showing a process of bending and forming a heat conduction plate in a plate-type heat exchanger according to an embodiment of the present invention.

FIG. 10e is a process diagram showing a process of bending and forming a heat conduction plate in a plate-type heat exchanger according to an embodiment of the present invention.

FIG. 11 is a schematic diagram showing a state in which a part of a plate-type heat exchanger according to the present invention and a part of a conventional plate-type heat exchanger are in contact with external air.

### BEST MODES OF THE INVENTION

Hereinafter, with reference to the accompanying drawings, embodiments of the present invention will be described in detail so as to be easily implemented by one of ordinary skill in the art to which the present invention pertains. The present invention may be embodied in a variety of forms and is not be limited to the embodiments described herein. In order to clearly describe the present invention, parts irrelevant to the description are omitted from the drawings; and throughout the specification, same or similar components are referred to as like reference numerals.

The words and terms used in the specification and claims of the present application are not to be construed as being limited to their ordinary or dictionary meanings, but should be interpreted as meanings and concepts consistent with the technical spirit of the present invention, based on the principle that the inventor may define terms and concepts to best describe his invention.

Therefore, the configurations shown in the embodiments described in the specification and the drawings correspond to preferred embodiments of the present invention, and do not represent the entire technical ideas of the present invention, so the configurations may have various equivalents and variations to replace them at the time of filing the present invention.

In the specification, terms such as “comprise” or “have” are intended to explain that a feature, number, step, operation, component, part or combination thereof described in the specification is present, but should not be construed to preclude the possibility of the presence or addition of one or more other features, numbers, steps, operations, components, parts or combinations thereof.

When a component is said to be “before”, “after”, “above” or “below” another component, it includes a case in which the component is placed “before”, “after”, “above” or “below” another component so as to be in direct contact with each other, as well as a case where any additional component is disposed between the two components, unless there are special circumstances. In addition, when a component is said to be “connected” to another component, it includes cases where they are not only directly connected to each other but also indirectly connected to each other, unless there are special circumstances.

Hereinafter, a plate-type heat exchanger according to an embodiment of the present invention will be described with reference to the drawings.

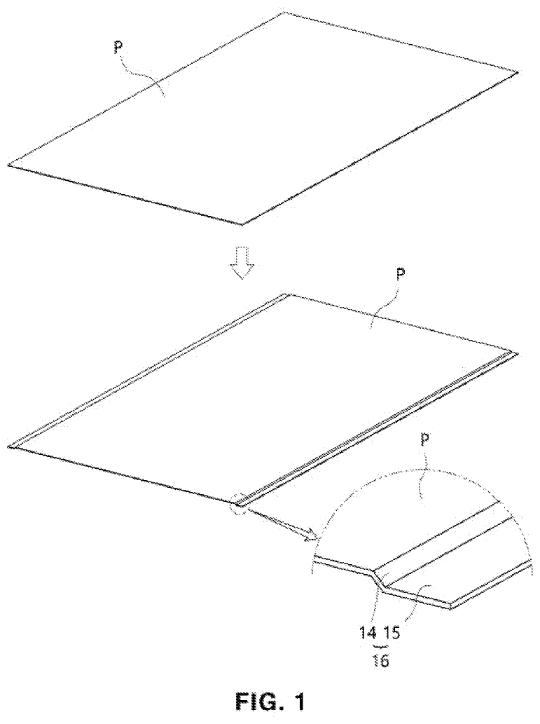

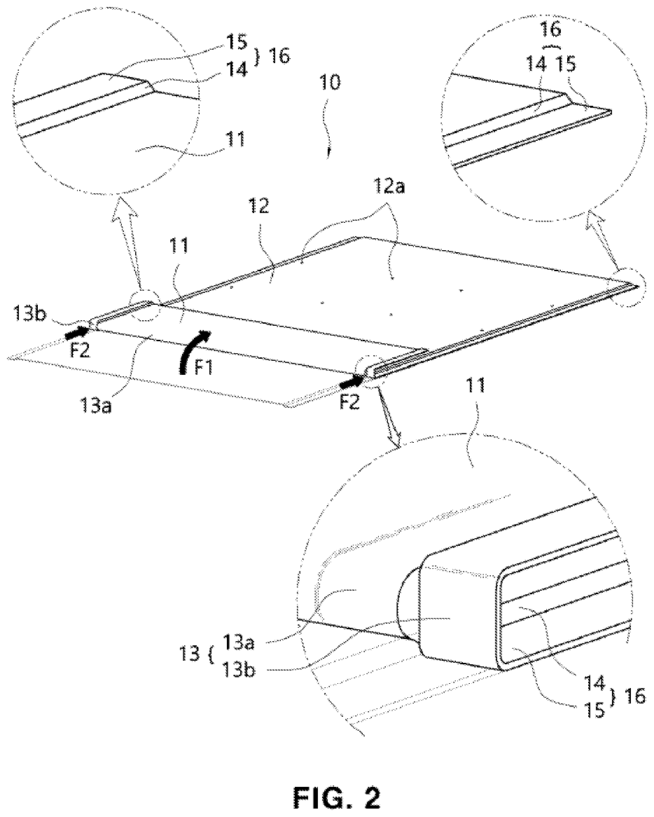

FIG. 1 is a perspective view showing a heat conduction plate of a plate-type heat exchanger according to an embodiment of the present invention, in which a bending portion is formed to be bent, and FIG. 2 is a perspective view showing a heat conduction plate of a plate-type heat exchanger according to an embodiment of the present invention, in which a bending portion is formed to be bent.

The plate-type heat exchanger 100 according to a preferred embodiment of the present invention may include a heat transfer assembly 30 comprising a plurality of heat transfer shells 20, wherein each of the plurality of heat transfer shells 20 comprises a pair of heat conduction plates 10.

As shown in FIG. 1, one of the pair of heat conduction plates 10 can be provided by preparing a plate P having an approximately square plate shape, and then first bending both side edges of the plate outward using a mold (not shown) to form a pair of flange portions 16.

As shown in FIG. 2, this heat conduction plate 10 may include a first heat transfer portion 11 and a second heat transfer portion 12 facing each other at a certain distance by a bending portion 13 formed in the middle of the length.

The flange portion 16 may include an inclined surface 14 inclined at a certain angle from both side edges of the first and second heat transfer portions, and a planar joint surface 15 extending horizontally outward from the end of the inclined surface and having a different height from the first and second planar heat transfer portions due to the inclined surface 14.

The plate P, which has the flange portions 16 bent outward at both side edges, may be secondarily bent in the middle of the length by the upper and lower mold bodies 40 and 50 of another mold, which will be described later, to form an approximately U-shaped bending portion 13, thereby forming a first heat transfer portion 11 and a second heat transfer portion 12 that are parallel while facing each other at a certain distance.

The bending portion 13 may include a first bending portion 13a having a substantially arc-shaped cross-section, which connects the first heat transfer portion 11 and the second heat transfer portion 12 to each other and is in contact with a second fluid (G) to be described later, and a second bending portion 13b having a substantially plate shape, which connects the flange portion 16 formed at both side edges of the first heat transfer portion 11 and the other flange portions formed at both side edge of the second heat transfer portion 12.

In this case, a curved portion connecting the arc-shaped cross-section and the plate-shaped cross-section may be formed between the first bending portion having the arc-shaped cross-section and the second bending portion having the plate-shaped cross-section.

In addition, the gap between the flange portions 16 that are bent and formed at both side edges of each of the first and second heat transfer portions 11 and 12 and face each other is formed to be relatively wider than the gap between the first and second heat transfer portions 11 and 12 facing each other, whereby the inlet and outlet of a first passage (S1), which is an internal passage of the heat transfer shell 20, can be secured wider, thereby allowing the inflow and discharge of a first fluid passing in one direction through the first passage during heat exchange more smoothly.

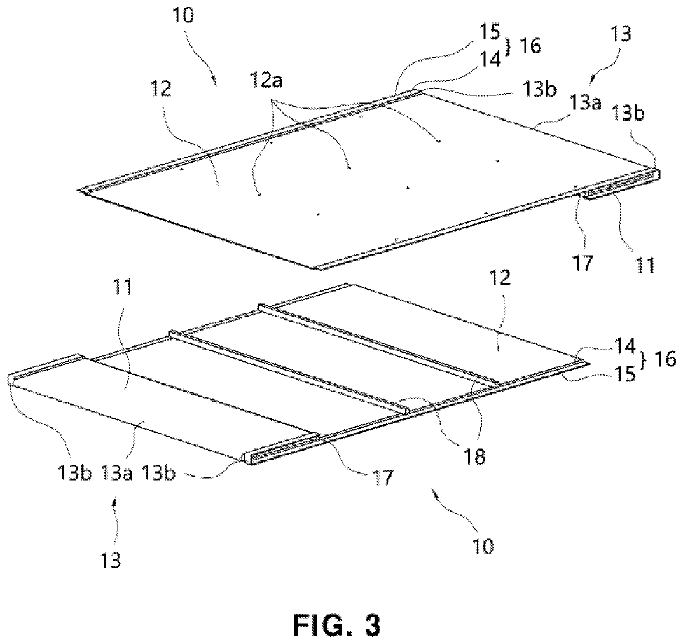

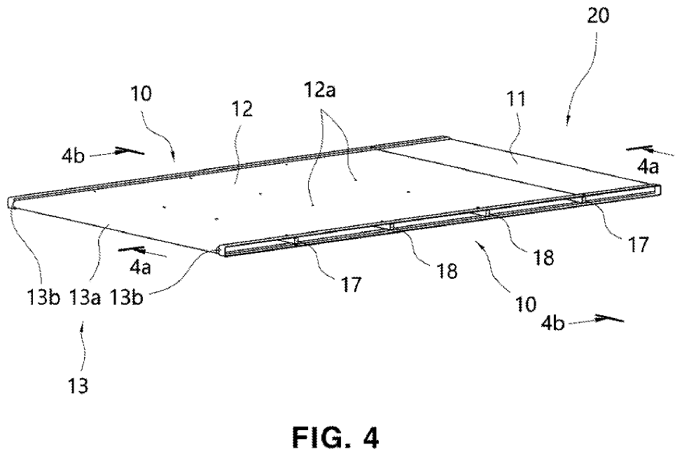

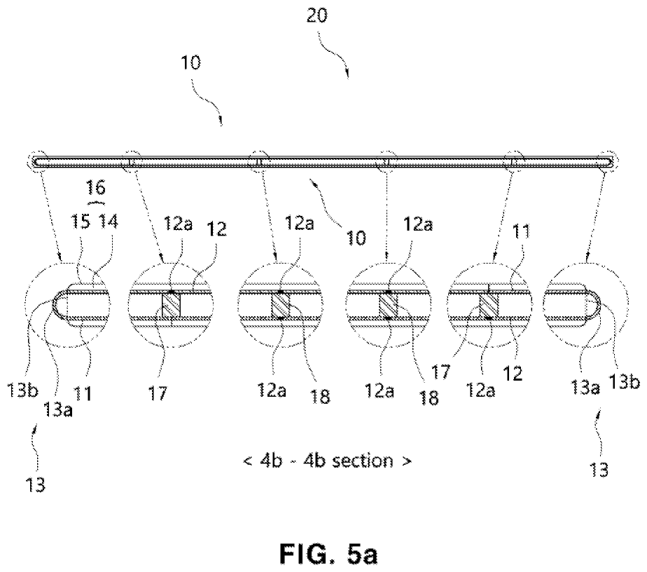

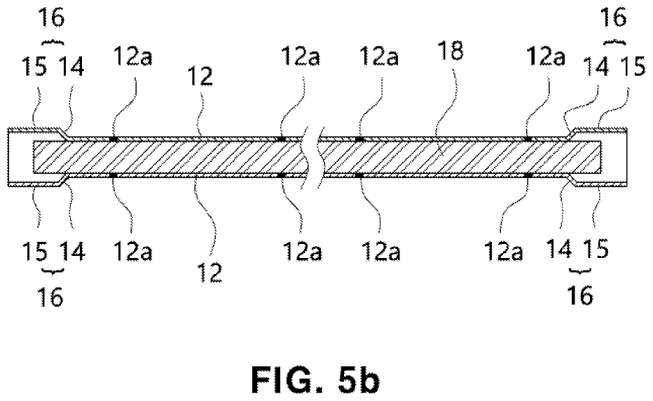

FIG. 3 is a perspective view showing a heat conduction plate of a plate-type heat exchanger according to an embodiment of the present invention, which is provided with a spacer bar; FIG. 4 is a perspective view showing a heat transfer shell formed by welding the heat conduction plates of a plate-type heat exchanger according to an embodiment of the present invention; FIG. 5A is a cross-sectional view taken along line 4a-4a in FIG. 4; and FIG. 5B is a cross-sectional view taken along line 4b-4b in FIG. 4.

As shown in FIGS. 3 and 4, the heat transfer shell 20 may include the first passage (S1) formed by welding an end of the first heat transfer portion 11 of the heat conduction plate 10 located at the upper side in the drawing and an end of the second heat transfer portion 12 of the other heat conduction plate 10 located at the lower side of the drawing in contact with each other, and by welding an end of the second heat transfer portion 12 of the heat conduction plate 10 located at the upper side in the drawing and an end of the first heat transfer portion 11 of the other heat conduction plate 10 located on the lower side of the drawing in contact with each other, wherein the first passage (S1) allows a first fluid (A), a low-temperature gas such as air flowing in from the outside, to pass in one direction.

In addition, the heat transfer shell 20 may have a heat transfer area of one of the first and second heat transfer portions 11 and 12 that is relatively smaller than that of the other heat transfer portion, and thus may include a pair of heat conduction plates in which the first heat transfer portion 11 and the second heat transfer portion 12 provided in one heat conduction plate have different heat transfer areas.

In this case, a pair of welded connection areas where the respective ends of the first and second heat transfer portions 11 and 12 having different heat transfer areas are welded in contact with each other may be positioned differently on both bending portions 13.

The pair of heat conduction plates 10 provided in the heat transfer shell 20 are shown and described as being provided so that the heat transfer area of the first heat transfer portion 11 is relatively smaller than that of the second heat transfer portion 12 as shown in FIGS. 3 and 4, but are not limited thereto, and the heat transfer area of the first heat transfer portion 11 may be relatively larger than that of the second heat transfer portion 12.

In addition, the heat transfer shell 20 may include a plurality of spacing bars 17 and 18 that maintain the gap formed between the first and second heat transfer portions of the heat conduction plate parallel to each other to be constant.

As shown in FIGS. 3, 4 and 5A and 5B, in case where the heat transfer areas of the first heat transfer portion 11 and the second heat transfer portion 12 in the pair of heat conduction plates 10 constituting the heat transfer shell 20 are different from each other, the plurality of spacing bars may include a first spacing bar 17 fixedly installed at a joint area where the respective ends of the first and second heat transfer portions having different heat transfer areas are welded in contact with each other, and a second spacing bar 18 fixedly installed between the heat transfer portions facing each other.

The first spacing bar 17 may be a bar member with an approximately square cross-section in which one side is simultaneously welded to a pair of joint areas, and the other side is welded through a weld hole 12a formed through the heat transfer portion having a relatively large heat transfer area, wherein the pair of joint areas are formed adjacent to the both side bending portions 13 of the heat transfer shell, respectively, by welding the respective ends of the first and second heat transfer portions provided in different heat conduction plates in contact with each other.

The second spacing bar 18 may be a bar member with an approximately square cross-section in which both sides are welded and connected in contact through another weld hole 12a formed through the heat transfer portions facing each other and having relatively large heat transfer areas among the first and second heat transfer portions provided in different heat conduction plates.

Preferably, the plurality of spacing bars including the first and second spacing bars 17 and 18 are arranged so that both ends are located at the inlet and outlet ends that are open at both sides of the heat transfer shell, respectively, and they are spaced apart at a certain distance so as not to impede the one-way flow of the first fluid (A) through the first passage (S1).

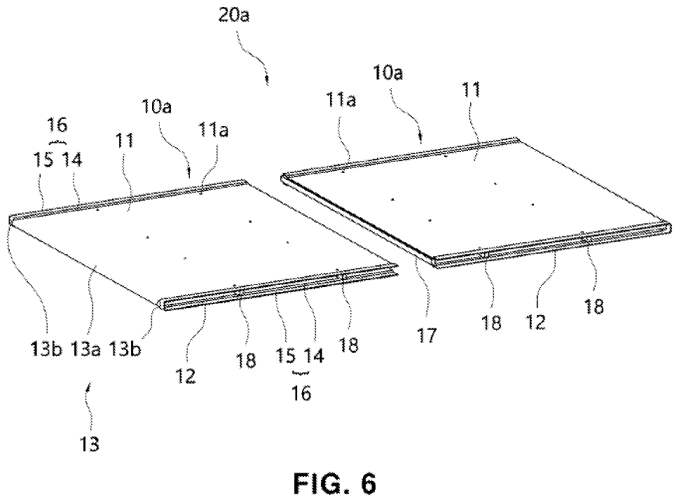

FIG. 6 is a perspective view showing another heat transfer shell formed in a plate-type heat exchanger according to an embodiment of the present invention.

The heat transfer shell 20 may include a pair of heat conduction plates 10 in which the heat transfer areas of the first heat transfer portion 11 and the second heat transfer portion 12 are the same, whereby a pair of welded connection areas, where the respective ends of the first and second heat transfer portions 11 and 12 having the same heat transfer area are welded in contact with each other, may face each other while being positioned on the same vertical line.

The pair of heat conduction plates 10 provided in the heat transfer shell 20 are shown and described as being provided so that the heat transfer areas of the first and second heat transfer portions 11 and 12 of one heat conduction plate 10 are same as that of the first and second heat transfer portions 11 and 12 of the other heat conduction plate as shown in FIG. 6, but are not limited thereto, and the first and second heat transfer portions 11 and 12 having the same heat transfer area in one heat conduction plate 10 and the first and second heat transfer portions 11 and 12 having the same heat transfer area in the other heat conduction plate 10 may have different sizes, and thus, the welded connection area located on the same vertical line may be located biased toward one of the pair of bending portions 13.

In addition, the heat transfer shell 20 may include a plurality of spacing bars 17 and 18 that maintain the gap formed between the first and second heat transfer portions of the heat conduction plate parallel to each other to be constant.

As shown in FIGS. 6, in case where the heat transfer areas of the first heat transfer portion 11 and the second heat transfer portion 12 in the pair of heat conduction plates 10 constituting the heat transfer shell 20 are the same, the plurality of spacing bars may include a first spacing bar 17 with both sides fixed to a pair of joint area where the respective ends of the first and second heat transfer portions having the same heat transfer area and being in contact with each other are welded in contact with each other, and a second spacing bar 18 that is fixedly installed by welding both sides through a weld hole formed through the heat transfer portion having the same heat transfer area and facing each other.

The first spacing bar 17 may be a bar member with a square cross-section in which both sides are simultaneously welded in contact with a pair of joint areas on the same vertical line, respectively, by welding the respective ends of the first and second heat transfer portions provided in different heat conduction plates in contact with each other.

The second spacing bar 18 may be a bar member with an approximately square cross-section in which both sides are welded and connected in contact through another weld hole 12a formed through the heat transfer portions facing each other for each different heat conduction plate.

Here, the weld hole 12a is shown and explained as being formed through each of the first heat transfer portion and the second heat transfer portion 12 in an approximately circular shape to expose one side of the spacing bar, but is not limited thereto, and may be formed in the form of a long hole to increase joint strength after being welded to the first and second heat transfer portions.

In addition, one side of the spacing bar corresponding to the joint portion, where the respective ends of the pair of heat conductive plates are welded in contact with each other, may be provided with a weld groove having a certain length that is formed to be recessed in the longitudinal direction so that the worker can easily check the welding position of the joint portion and increase the joint strength after welding.

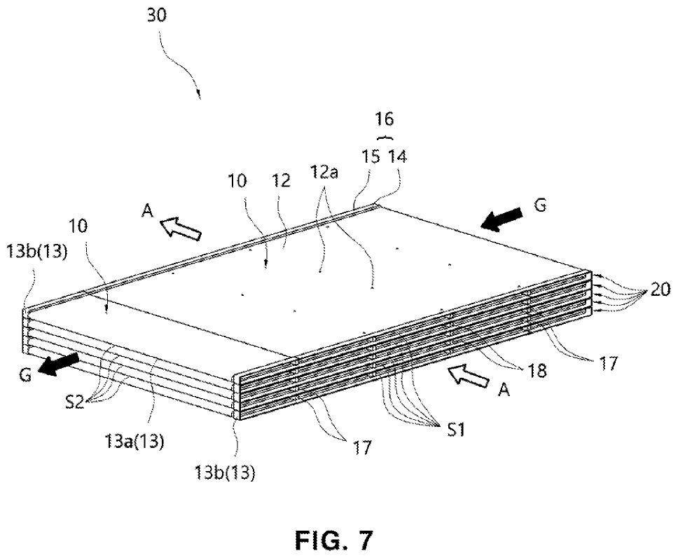

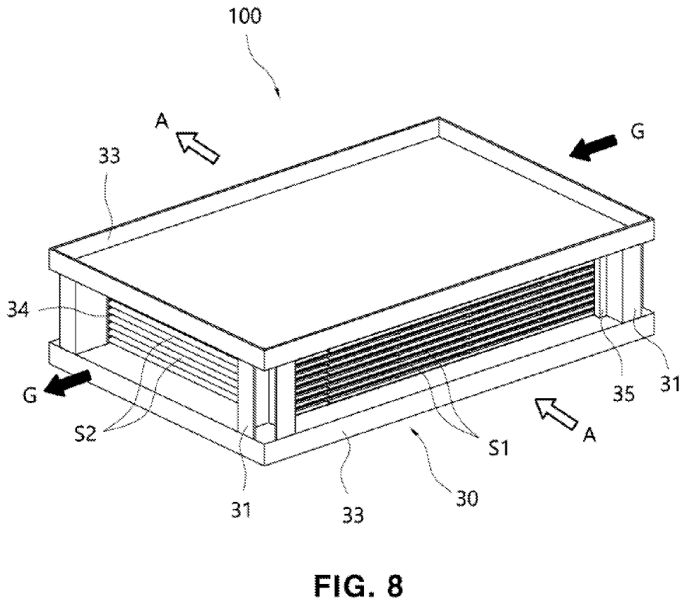

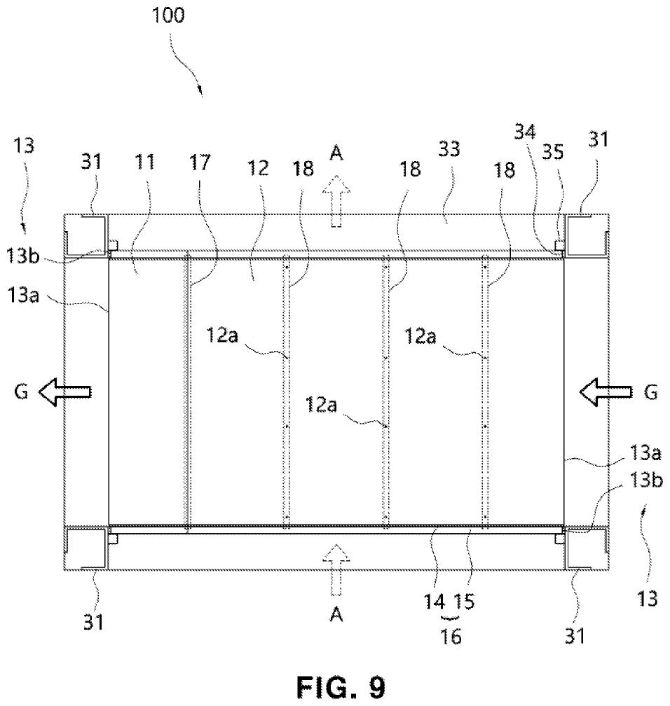

FIG. 7 is a perspective view showing a heat transfer assembly of a plate-type heat exchanger according to an embodiment of the present invention; FIG. 8 is a perspective view showing a plate-type heat exchanger according to an embodiment of the present invention; and FIG. 9 is a plan view showing a plate-type heat exchanger according to an embodiment of the present invention.

As shown in FIGS. 7, 8 and 9, the heat transfer assembly 30 comprises a roughly hexahedral rigid structure in which a plurality of heat transfer shells 20 are stacked in multiple layers so that the both side flange portions 16 of the heat conduction plate 10 provided in the heat transfer shell 20 and the both side flange portions 16 of the other heat conduction plate 10 provided in the other heat transfer shell 20 are welded in contact with each other, thereby forming a second passage (S2) between the adjacent heat transfer shells 20, wherein the second passage (S2) intersects the first passage at a right angle and allows a second fluid (G), which is a high-temperature gas such as exhaust gas having a relatively higher temperature than external air, to pass through it.

That is, when the heat transfer shells 20 are stacked in a vertical direction in the drawing, the joint surface 15 of the flange portion 16 orthogonal to the first passage of the heat transfer shell 20 may be integrally welded in surface-to-surface contact with another flange portion provided in another adjacent heat transfer shell.

Accordingly, the first passage (S1), which is an internal passage of the plurality of heat transfer shells 20, intersects at an approximately right angle with the second passage (S2) formed between the stacked heat transfer shells, whereby the first fluid (A), which is external air passing through the first passage (S1), is not mixed with the second fluid (G) passing in one direction through the second passage, and thus, the first fluid and the second fluid having different temperatures and passing through the heat transfer assembly 30 can exchange heat without physical contact.

The heat exchanger may include a plurality of vertical frames 31 located at each corner of the heat transfer assembly 30, an upper frame 32 fixed to each upper end of the plurality of vertical frames so that its lower surface is in contact with the uppermost heat transfer shell 20 among the plurality of stacked heat transfer shells, and a lower frame 33 fixed to each lower end of the plurality of vertical frames so that its upper surface is in contact with the lowest heat transfer shell 20 among the plurality of stacked heat transfer shells, and further include a plurality of stopper bars 35 that are fixed to one side of each of the plurality of vertical frames corresponding to the flange portion of the heat conduction plate to come into contact with the end of the flange portion.

The heat exchanger may include at least one sealing material 34 which is made of an elastic material such as Teflon or rubber, and is interposed between each other side of the plurality of vertical frames 31 corresponding to the second bending portion 13b formed at both ends of the bending portion 13, and the second bending portion formed in a flat plate shape.

Accordingly, the inlet and outlet of each first passage (S1) of the plurality of heat transfer shells 20 stacked in multiple layers can be aligned on the same vertical line by means of a stopper bar 35 that is fixedly installed on one side of the vertical frame 31 and comes into contact with the end of each flange portion provided in each heat conduction plate of the multi-layered heat transfer shell 20.

In addition, the second fluid (G), which flows into the inlet of the second passage (S2) formed between the stacked heat transfer shells and is discharged to the outlet, can be safely prevented from leaking to the outside through the gap formed between the plurality of vertical frames and the heat transfer assembly by means of the sealing material 34 interposed between the vertical frame 31 and the second bending portion 13b.

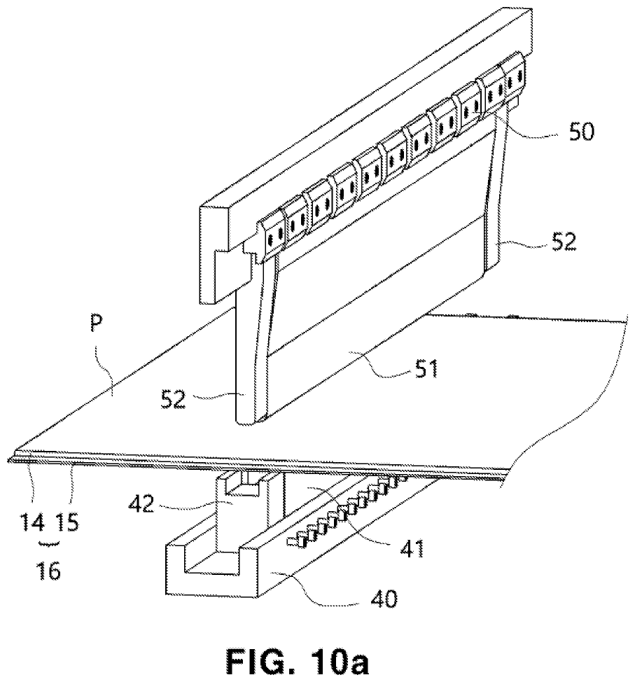

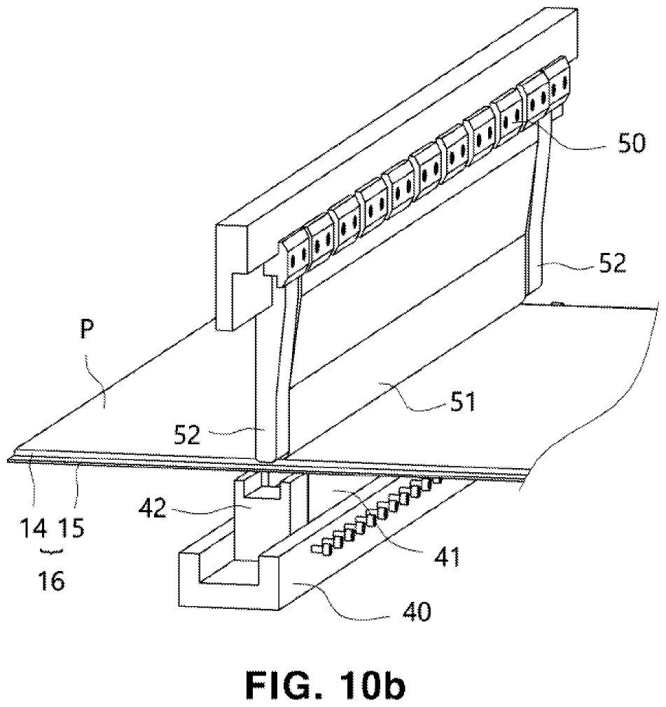

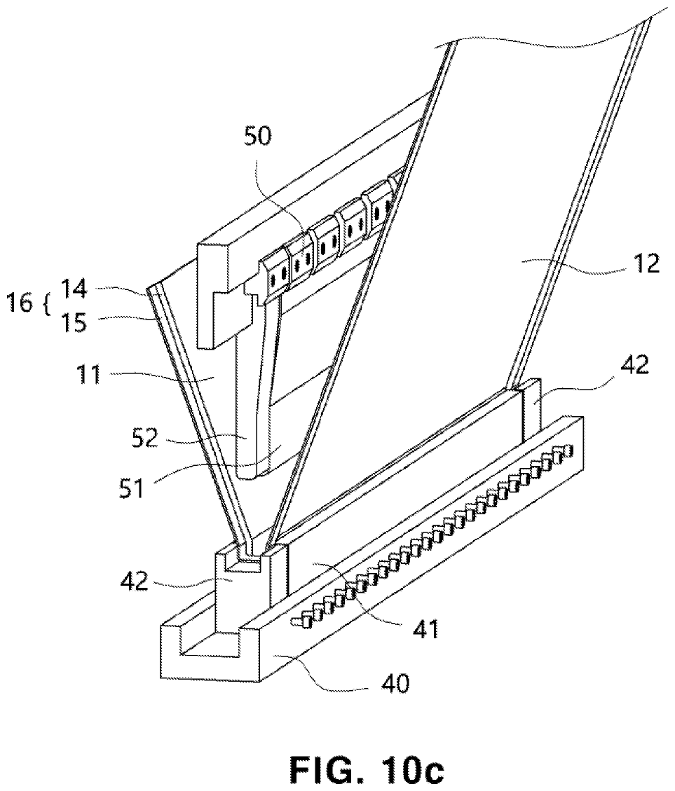

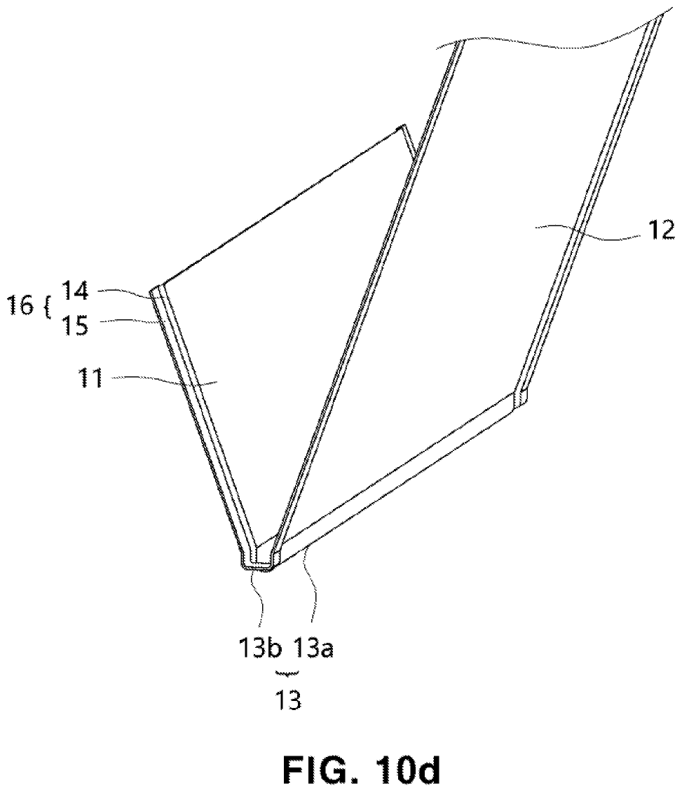

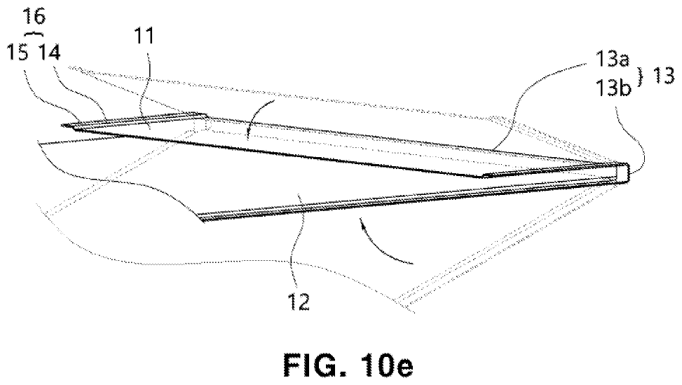

FIGS. 10a to 10e are process diagrams showing a process of bending and forming a heat conduction plate in a plate-type heat exchanger according to an embodiment of the present invention.

As shown in FIGS. 10a and 10b, a plate (P), which has the flange portions 16 formed at both side edges by first bending, is secondarily bent in a direction perpendicular to the flange portion using a mold to form the heat conduction plate 10 having the bending portion 13, wherein the mold includes a lower mold body 40 fixed to a base (not shown), and an upper mold body 50 that moves up and down with respect to the lower mold body by an actuator such as a hydraulic cylinder.

The lower mold body 40 may include a first lower mold 41 having a first concave portion with a bottom surface recessed downward, and a pair of second lower molds 42 each having a second concave portion with a flat bottom surface and disposed at both sides of the first lower mold.

The upper mold body 50 may include a first upper mold 51 having a first convex portion whose lower end corresponding to the first concave portion protrudes convexly downward, and a pair of second upper molds 52 each having a second convex portion whose lower end corresponding to the second concave portion protrudes flatly and disposed at both sides of the first upper mold.

The first and second lower molds 41 and 42 and the first and second upper molds 51 and 52 can be detachably fixed to the upper and lower mold bodies 40 and 50 by a plurality of fastening members so that they face each other one to one.

As shown in FIG. 10c, when the upper mold body is lowered directly downward by the actuator to pressurize the plate and then return upward in a state where the plate (P) having the flange portions 16 formed at both side edges by first bending is placed on the first and second lower molds of the lower mold body, the first and second lower molds of the lower mold body can be joined to the first and second upper molds of the upper mold body with the plate between them and secondarily bend the plate to form the bending portion 13.

In this case, a first bending portion 13a having an approximately arc-shaped cross-section can be bent and formed by the first concave portion and the first convex portion at the bent area of the plate where the first lower mold and the first upper mold are joined together, while a second bending portion 13b having an approximately plate shape can be bent and formed by the second concave portion and the second convex portion at the bent area of the plate where the second lower mold and the second upper mold are joined together, thereby bending and forming the bending portion 13 in which the planar second bending portion is continuously formed at both sides of the first bending portion 13a having an arc-shaped cross-section.

Then, after the upper mold body 50 returns upward, the bending portion 13 having the first and second bending portions is formed on the plate (P) and the heat conduction plate 10 remaining in the lower mold body is separated.

Finally, as shown in FIGS. 10d and 10e, the first heat transfer portion and the second heat transfer portion connected to each other with the bending portion 13 between them are spread in an approximately V-shape. Therefore, the heat conduction plate is placed on a workbench with a flat top surface, and then an external force is applied to deform the first heat transfer portion and the second heat transfer portion so that they are parallel to each other, thereby completing the bending and forming process for the heat conduction plate.

Meanwhile, when designing a plate-type heat exchanger, safety against corrosion must be considered as one of various design conditions.

For example, in a structure where heat exchange is performed, when the surface temperature of the heat conduction plate drops to the acid dew point or lower water dew point, condensation and thus corrosion occur in a specific area. If frequent corrosion occurs in a specific area exposed to the acid dew point, the replacement cycle for parts located in that area becomes frequent, the durability of the heat exchanger deteriorates, and the service life of the heat exchanger is shortened.

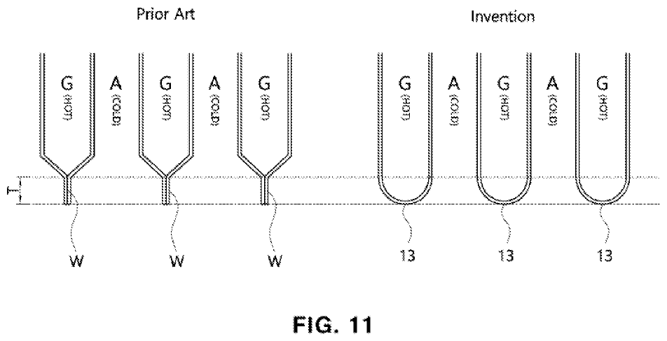

That is, in the case of a conventional plate-type heat exchanger having a welded flange portion (W) where the flange portions of a pair of heat conduction plates are connected by welding, as shown in FIG. 11, the heat of the second fluid (G), which is a high-temperature gas, is not transferred to the welded flange portion (W) located in the exposed area (T) that is in contact with room temperature outside air at the inlet where the first fluid (A) flows. Therefore, the temperature drops quickly due to contact with the room temperature outdoor air.

In this case, when the temperature of the heat transfer plate having the welded flange portion (W) located in the exposure area (T) decreases to approach the acid dew point generation temperature, the acid dew points occur at a high rate on the surface of the heat transfer plate located at the entrance of the first passage.

On the other hand, in the case of the plate-type heat exchanger of the present invention having an arc-shaped bending portion 13, as shown in FIG. 11, the heat of the second fluid (G), which is a high-temperature gas, is directly transferred to the bending portion 13 located in the exposed area (T), preventing a rapid temperature drop due to contact with the outside air at room temperature.

When the acid dew point generation temperature of the second fluid, which is a high-temperature gas, is approximately 110° C. to 130° C., the temperature of the second fluid, which is a high-temperature gas discharged after losing heat through heat exchange with the first fluid, which is a low-temperature gas, can be stably maintained above the acid dew point generation temperature at the inlet of the first passage through which the first fluid flows. Therefore, it is possible to prevent the acid dew point from occurring on the surface of the heat transfer plate that is in direct contact with the second fluid, which is a high-temperature gas.

The temperature drop at the bending portion 13 of the plate-type heat exchanger of the present invention can be minimized while maintaining a significantly lower rate compared to the temperature drop at the welded flange portion (W) of the conventional plate-type heat exchanger. Therefore, the occurrence of the acid dew point, which causes corrosion, can be fundamentally prevented, thereby extending the service life of the plate-type heat exchanger and reducing maintenance costs caused by corrosion.

Although an embodiment of the present invention have been described, the spirit of the present invention is not limited to the embodiment presented in the subject specification; and those skilled in the art who understands the spirit of the present invention will be able to easily suggest other embodiments through addition, changes, elimination, and the like of elements without departing from the scope of the same spirit, and such other embodiments will also fall within the scope of the present invention.

What is claimed is:

1. A plate-type heat exchanger comprising a heat transfer assembly, wherein the heat transfer assembly includes a plurality of heat transfer shells stacked in multiple layers, wherein each of the heat transfer shells include a pair of heat conduction plates;
wherein each of the heat conduction plates has a pair of flange portions bent at both side edges, and a first heat transfer portion and a second heat transfer portion facing each other at a certain distance by a bending portion bent and formed in the middle of the length;
wherein the heat transfer shell includes a first passage, through which a first fluid passes, formed by welding the end of the first heat transfer portion of one of the pair of heat conduction plates and the end of the second heat transfer portion of the other heat conduction plate in contact with each other and by welding the end of the second heat transfer portion of the one heat conduction plate and the end of the first heat transfer portion of the other heat conduction plate in contact with each other;
wherein the plurality of heat transfer shells are stacked in multiple layers by welding both side flange portions of the heat conduction plate provided in the heat transfer shell and both side flange portions of the other heat conduction plate provided in the other heat transfer shell, whereby a second passage through which a second fluid passes is formed between the adjacent heat transfer shells to intersect the first passage; and
wherein heat exchange occurs between the first fluid passing through the first passage and the second fluid passing through the second passage without physical contact.

2. The plate-type heat exchanger according to claim 1, wherein the bending portion includes a first bending portion having an arc-shaped cross-section, which connects the first heat transfer portion and the second heat transfer portion to each other, and a second bending portion having a plate shape, which connects the flange portions formed at both side edges of the first heat transfer portion and the other flange portions formed at both side edge of the second heat transfer portion.

3. The plate-type heat exchanger according to claim 1, wherein the heat transfer shell includes: a pair of heat conduction plates in which the heat transfer area of the first heat transfer portion is different from that of the second heat transfer portion; and
a plurality of spacing bars that maintain a constant gap formed between the first and second heat transfer portions having different heat transfer areas and facing each other.

4. The plate-type heat exchanger according to claim 3, wherein the plurality of spacing bars include a first spacing bar in which one side thereof is welded and connected to a joint area where the respective ends of the first and second heat transfer portions having different heat transfer areas are welded and connected in contact with each other, and the other side is welded and connected to a heat transfer portion corresponding to the joint portion; and a second spacing bar in which both sides thereof are welded and connected in contact with the heat transfer portions facing each other.

5. The plate-type heat exchanger according to claim 1, wherein the heat transfer shell includes: a pair of heat conduction plates in which the heat transfer area of the first heat transfer portion is the same as that of the second heat transfer portion; and
a plurality of spacing bars that maintain a constant gap formed between the first and second heat transfer portions having the same heat transfer areas and facing each other.

6. The plate-type heat exchanger according to claim 5, wherein the plurality of spacing bars include a first spacing bar in which both sides thereof are welded and connected to both sides of the joint area where the respective ends of the first and second heat transfer portions having the same heat transfer area are welded and connected in contact with each other; and a second spacing bar in which both sides thereof are welded and connected in contact with the first and second heat transfer portions facing each other.

7. The plate-type heat exchanger according to claim 1, wherein the heat exchanger includes a plurality of vertical frames located at each corner of the heat transfer assembly, an upper frame fixed to each upper end of the plurality of vertical frames so that its lower surface is in contact with the uppermost heat transfer shell among the plurality of stacked heat transfer shells, a lower frame fixed to each lower end of the plurality of vertical frames so that its upper surface is in contact with the lowest heat transfer shell among the plurality of stacked heat transfer shells, and a plurality of stopper bars that are fixed to one side of each of the plurality of vertical frames corresponding to the flange portion of the heat conduction plate to come into contact with the end of the flange portion.

8. The plate-type heat exchanger according to claim 7, wherein the heat exchanger includes at least one sealing material which is interposed between each other side of the plurality of vertical frames corresponding to the second bending portion formed at both ends of the bending portion, and the second bending portion formed in a flat plate shape.

9. A method of manufacturing a plate-type heat exchanger, the method comprising:
providing a square plate-shaped plate;
preparing a heat conduction plate by first bending flange portions at both side edges of the plate and secondarily bending a bending portion connecting a first heat transfer portion and a second heat transfer portion so that they face each other and are parallel at a certain distance;
forming a heat transfer shell having a first passage, through which a first fluid passes, by welding and connecting an end of the first heat transfer portion of the heat conduction plate and an end of the second heat transfer portion of another heat conduction plate in contact with each other, and by welding and connecting an end of the second heat transfer portion of the heat conduction plate and an end of the first heat transfer portion of the other heat conduction plate in contact with each other; and
forming a heat transfer assembly having a second passage, through which a second fluid passes, by stacking a plurality of heat transfer shells in multiple layers so that both side flange portions of the heat conduction plate provided in the heat transfer shell and both side flange portions of another heat conduction plate provided in another heat transfer shell are in contact with each other, whereby the second passage is formed between the adjacent heat transfer shells to intersect the first passage;
wherein heat exchange occurs between the first fluid passing through the first passage and the second fluid passing through the second passage without physical contact.

10. The method of manufacturing a plate-type heat exchanger according to claim 9, wherein in the step of preparing the heat conduction plate,
a mold is used, wherein the mold includes a lower mold body including a first lower mold and a pair of second lower molds each having a bottom surface respectively disposed at both sides of the first lower mold, and an upper mold body including a first upper mold and a pair of second upper molds respectively disposed at both sides of the first upper mold;
when the upper mold body is lowered directly downward by an actuator to pressurize the plate and then return upward in a state where the plate having the flange portions formed at both side edges by first bending is placed on the first and second lower molds of the lower mold body, the first and second lower molds of the lower mold body can be joined to the first and second upper molds of the upper mold body with the plate between them and secondarily bend the plate to form the bending portion.

11. The method of manufacturing a plate-type heat exchanger according to claim 10, wherein the first lower mold includes a first concave portion with a bottom surface recessed downward, the second lower mold includes a second concave portion with a flat bottom surface; and
the first upper mold includes a first convex portion whose lower end corresponding to the first concave portion protrudes convexly downward, and the second upper mold includes a second convex portion whose lower end corresponding to the second concave portion protrudes flatly.

12. The method of manufacturing a plate-type heat exchanger according to claim 11, wherein a first bending portion having an arc-shaped cross-section is bent and formed by the first concave portion and the first convex portion, while a second bending portion having a plate shape is bent and formed by the second concave portion and the second convex portion, thereby bending and forming the bending portion in which the second bending portion is continuously formed at both sides of the first bending portion.

13. The method of manufacturing a plate-type heat exchanger according to claim 9, wherein in the step of forming the heat transfer shell,
the heat transfer shell includes a pair of heat conduction plates in which the heat transfer area of the first heat transfer portion is different from that of the second heat transfer portion,
one side of a first spacing bar is welded and connected to a joint area where the respective ends of the first and second heat transfer portions having different heat transfer areas are welded and connected in contact with each other; the other side of the first spacing bar is welded and connected to a relatively wide heat transfer portion; and both sides of a second spacing bar are be welded and connected in contact with the heat transfer portions facing each other.

14. The method of manufacturing a plate-type heat exchanger according to claim 9, wherein in the step of forming the heat transfer shell,
the heat transfer shell includes a pair of heat conduction plates in which the heat transfer area of the first heat transfer portion is the same as that of the second heat transfer portion,
both sides of a first spacing bar are welded and connected to both side joint areas where the respective ends of the first and second heat transfer portions having the same heat transfer areas are welded and connected in contact with each other; and both sides of a second spacing bar are welded and connected in contact with the heat transfer portions facing each other.
